(19) United States
(12) Patent Application Publication
(10) Pub. No.: US 2018/0207844 A1
(43) Pub. Date: Jul. 26, 2018

(54) METHOD OF PRESS-SHAPING HANDLE GRIP

(71) Applicant: HIGH CEDAR ENTERPRISE CO., LTD., TAICHUNG CITY (TW)

(72) Inventor: Yung-Han WANG, TAICHUNG CITY (TW)

(21) Appl. No.: 15/414,106

(22) Filed: Jan. 24, 2017

(51) Int. Cl. B29C 43/02; B29C 43/52; B29C 35/02; B29C 35/16; B29C 43/36; B25G 1/10

(52) U.S. Cl. CPC B29C 43/02; B29C 43/52; B29C 35/02; B29L 2023/00; B29C 43/36; B25G 1/10; B29C 35/16

(57) ABSTRACT

A method of press-shaping a handle grip includes the steps of: providing an unshaped handle grip having a body portion, a middle hole, and an end head; providing an insertion rod having a body insertion portion for being inserted into the middle hole of the unshaped handle grip; providing a lower die and an upper die which can be pressed together, wherein the lower die and the upper die have body cavities, respectively, for receiving the body portion of the unshaped handle grip, and escape cavities adapted to communicate with the body cavities, respectively, and receive, but not press against, the end head of the unshaped handle grip; pressing together, then heating, and finally cooling the lower die and the upper die; and performing a mold-opening process to take a shaped handle grip thus obtained.

### BACKGROUND OF THE INVENTION

### 1. Field of the Invention

The present invention relates to technology about handle grips and, more particularly, to a method of press-shaping a handle grip.

### 2. Description of the Prior Art

Conventional handle grips are available for use immediately after they are manufactured by injection molding or foam molding. However, the material density or hardness of the handle grips thus manufactured fails to meet the required specifications and thereby leads to a need for a change in the manufacturing process or material constituents. Therefore, in view of the aforesaid drawback of the prior art, conventional methods of manufacturing handle grips still have room for improvement.

### SUMMARY OF THE INVENTION

In view of the aforesaid drawback of the prior art, it is an objective of the present invention to provide a method of press-shaping a handle grip in a manner to not only shape the handle grip after injection molding or foam molding with a view to increasing its material density or hardness, but also prevent materials from being squeezed out at end heads of the handle grip as a result of mold parting while the shaping is underway.

In order to achieve the above and other objectives, the present invention provides a method of press-shaping a handle grip, comprising the steps of: providing an unshaped handle grip having a body portion, a middle hole, and an end head; providing an insertion rod having a body insertion portion for being inserted into the middle hole of the unshaped handle grip; providing a lower die and an upper die which can be pressed together, wherein the lower die and the upper die have body cavities, respectively, for receiving the body portion of the unshaped handle grip, and escape cavities adapted to communicate with the body cavities, respectively, and receive, but not press against, the end head of the unshaped handle grip; pressing together, then heating, and finally cooling the lower die and the upper die; and performing a mold-opening process to take a shaped handle grip thus obtained.

Regarding the method of press-shaping a handle grip according to the present invention, the body portion for use in pressing against the unshaped handle grip is conducive to requirement compliance, whereas new parting lines are no longer produced, because one of the end heads of the unshaped handle grip is not pressed against, thereby achieving the objectives of the present invention.

Preferably, the shaped handle grip is smaller than the unshaped handle grip by 0.2% to 1%.

Preferably, the heating temperature ranges from 230° C. to 250° C.

Preferably, the heating duration ranges from 300 seconds to 500 seconds.

Preferably, the cooling duration ranges from 300 seconds to 450 seconds.

Preferably, the shaped handle grip has Rockwell hardness of 75-85.

Preferably, a neck portion is formed between the body portion and the end head of the unshaped handle grip, whereas the lower die and the upper die have wall portions, respectively, for being inserted into the neck portion of the unshaped handle grip.

Preferably, the lower die and the upper die have vents whereby the outsides of the lower die and the upper die are in communication with the body cavities, respectively.

Preferably, the insertion rod has a mold fixing portion, whereas the lower die and the upper die have clamping rod portions, respectively, for clamping the mold fixing portion of the insertion rod in place.

Preferably, the body cavity of the lower die is provided in a plural number such that the escape cavity of the lower die is in communication with the body cavities of the lower die, wherein the body cavity of the upper die is provided in a plural number such that the escape cavity of the upper die is in communication with the body cavities of the upper die.

Fine structures and features of the method of press-shaping a handle grip according to the present invention are described below with reference to a preferred embodiment of the present invention. However, persons skilled in the art understand that the detailed description and the preferred embodiment of the present invention are illustrative of the present invention rather than restrictive of the claims of the present invention.

### BRIEF DESCRIPTION OF THE DRAWINGS

FIG. 1 is a lateral exploded view of an unshaped handle grip according to a preferred embodiment of the present invention;

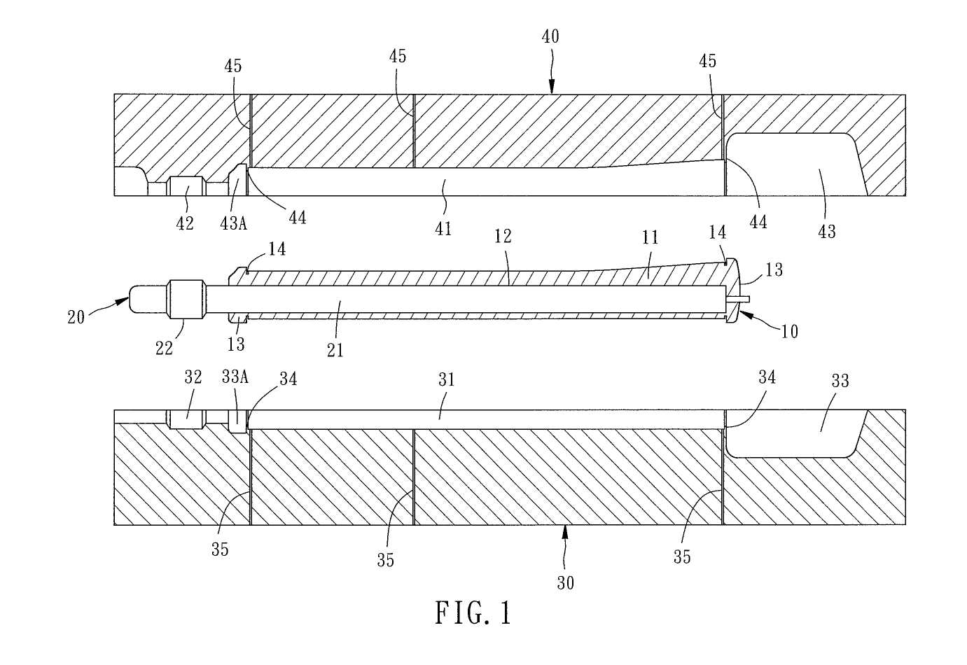

FIG. 2 is a top view of the unshaped handle grip assembled according to a preferred embodiment of the present invention;

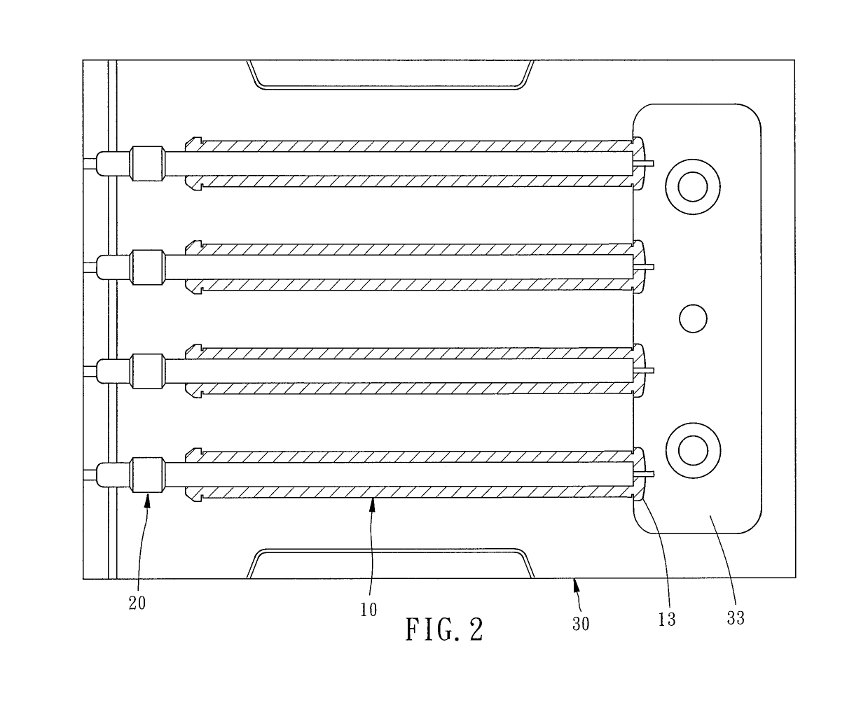

FIG. 3 is a lateral view of the unshaped handle grip assembled according to a preferred embodiment of the present invention; and

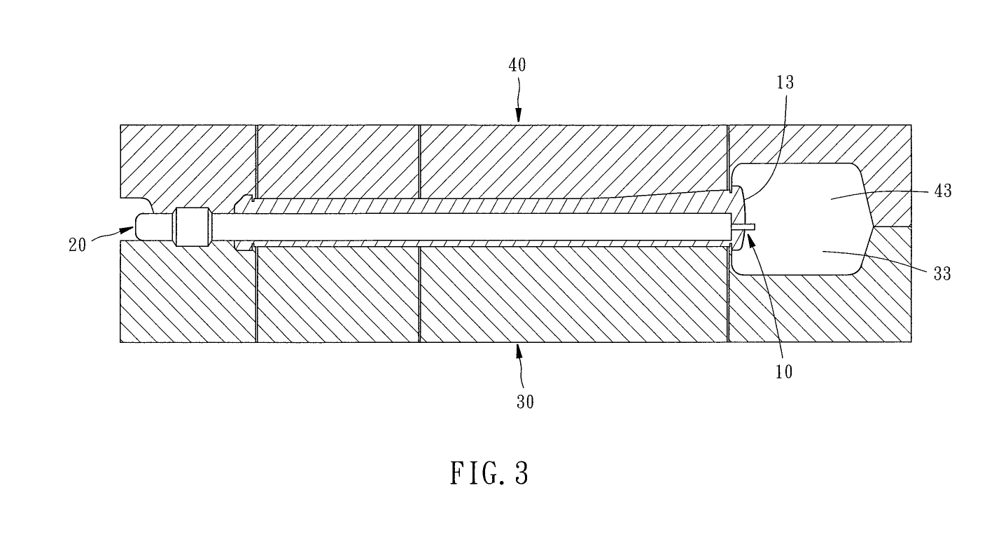

FIG. 4 is a perspective view of a shaped handle grip according to a preferred embodiment of the present invention.

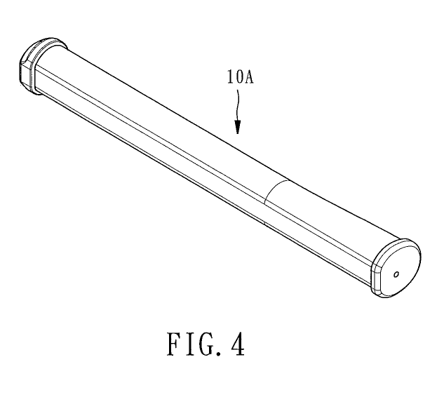

### DETAILED DESCRIPTION OF THE EMBODIMENT OF THE INVENTION

Directional words, such as “intra,” “outer,” “outside,” “upper,” and “lower,” used herein must be interpreted with reference to accompanying drawings.

The technical features of the present invention are described hereunder with reference to a preferred embodiment and the accompanying drawings of the present invention.

Referring to the accompanying drawings of the present invention, a method of press-shaping a handle grip according to a preferred embodiment of the present invention comprises the steps of:

providing an unshaped handle grip 10 having a body portion 11, a middle hole 12, and two end heads 13, wherein the end heads 13 each have a larger cross section than a terminal end of the body portion 11,

and a neck portion 14 is formed between the body portion 11 and each end head 13;

providing an insertion rod 20 having a body insertion portion 21 for being inserted into the middle hole 12 of the unshaped handle grip 10, and a mold fixing portion 22 connected to the body insertion portion 21;

providing a lower die 30 and an upper die 40 which can be pressed together, wherein the lower die 30 and the upper die 40 have body cavities 31, 41, respectively, for receiving the body portion 11 of the unshaped handle grip 10, and escape cavities 33, 43 adapted to communicate with the body cavities 31, 41, respectively, and receive, but not press against, one of the end heads 13 of the unshaped handle grip 10, allowing one of head cavities 33A, 43A to receive and press against the other end head 13,

wherein the lower die 30 and the upper die 40 have clamping rod portions 32, 42, respectively, for clamping the mold fixing portion 22 of the insertion rod 20 in place,

wherein the mold fixing portion 22 has a larger outer diameter than the body insertion portion 21, and the clamping rod portions 32, 42 are each larger than the mold fixing portion 22,

wherein the body cavity 31 is provided in a plural number such that the escape cavity 33 is in communication with the body cavities 31, whereas the body cavity 41 is provided in a plural number such that the escape cavity 43 is in communication with the body cavities 41,

wherein the lower die 30 and the upper die 40 have wall portions 34, 44, respectively, for being inserted into the neck portion 14 of the unshaped handle grip 10,

wherein the lower die 30 and the upper die 40 have vents 35, 45 whereby the outsides of the lower die 30 and the upper die 40 are in communication with the body cavities 31, 41, respectively,

pressing together, then heating, and finally cooling the lower die 30 and the upper die 40,

wherein the heating temperature ranges from 230° C. to 250° C.,

wherein the heating duration ranges from 300 seconds to 500 seconds,

wherein the cooling duration ranges from 300 seconds to 450 seconds, this embodiment adopts intra-mold cooling, and

performing a mold-opening process to take a shaped handle grip 10A thus obtained.

In a preferred embodiment of the present invention, the shaped handle grip 10A is smaller than the unshaped handle grip 10 by 0.2% to 1%.

The shaped handle grip 10A has Rockwell hardness of 75 to 85.

A variant embodiment of the present invention has some distinguishing technical features described below.

The handle grip has one end head 13 and one neck portion 14.

Alternatively, the end heads 13 are disposed at the two ends of the body portion 11 of the handle grip, respectively, whereas the escape cavities 33, 43 substitute for the head cavities 33A, 43A, respectively.

The vent 35 and/or the vent 45 are disposed on the parting surface of the lower die 30 and/or the parting surface of the upper die 40, respectively.

In conclusion, a method of press-shaping a handle grip according to the present invention not only entails performing a shaping process on the handle grip after injection molding or foam molding to increase its material density or hardness, but also prevents materials from being squeezed out at end heads 13 of the handle grip as a result of mold parting while the shaping is underway, thereby achieving the objectives of the present invention.

What is claimed is:

1. A method of press-shaping a handle grip, comprising the steps of:
providing an unshaped handle grip having a body portion, a middle hole, and an end head;
providing an insertion rod having a body insertion portion for being inserted into the middle hole of the unshaped handle grip;
providing a lower die and an upper die which can be pressed together, wherein the lower die and the upper die have body cavities, respectively, for receiving the body portion of the unshaped handle grip, and escape cavities adapted to communicate with the body cavities, respectively, and receive, but not press against, the end head of the unshaped handle grip;
pressing together, then heating, and finally cooling the lower die and the upper die; and
performing a mold-opening process to take a shaped handle grip thus obtained.

2. The method of claim 1, wherein the shaped handle grip is smaller than the unshaped handle grip by 0.2% to 1%.

3. The method of claim 1, wherein the heating temperature ranges from 230° C. to 250° C.

4. The method of claim 1, wherein the heating duration ranges from 300 seconds to 500 seconds.

5. The method of claim 1, wherein the cooling duration ranges from 300 seconds to 450 seconds.

6. The method of claim 1, wherein the shaped handle grip has Rockwell hardness of 75 to 85.

7. The method of claim 1, wherein a neck portion is formed between the body portion and the end head of the unshaped handle grip, whereas the lower die and the upper die have wall portions, respectively, for being inserted into the neck portion of the unshaped handle grip.

8. The method of claim 1, wherein the lower die and the upper die have vents whereby outsides of the lower die and the upper die are in communication with the body cavities, respectively.

9. The method of claim 1, wherein the insertion rod has a mold fixing portion, whereas the lower die and the upper die have clamping rod portions, respectively, for clamping the mold fixing portion of the insertion rod in place.

10. The method of claim 1, wherein the body cavity is provided in a plural number such that the escape cavity is in communication with the body cavities, whereas the body cavity is provided in a plural number such that the escape cavity is in communication with the body cavities.
